(19) United States
(12) Patent Application Publication
(10) Pub. No.: US 2026/0370539 A1
(43) Pub. Date: Nov. 19, 2026

(54) Methods and Apparatus for Link Status Alarm Condition Confirmation Prior to Alarm Generation and/or Notification

(71) Applicant: Charter Communications Operating, LLC, St. Louis, MO (US)

(72) Inventor: Saran Khalid, Denver, CO (US)

(21) Appl. No.: 19/211,536

(22) Filed: May 19, 2025

(51) Int. Cl. H04L 41/06; H04L 43/50

(52) U.S. Cl. CPC H04L 41/06; H04L 43/50

(57) ABSTRACT

A base station generates and sends an alert of the risk of alarm generation, regarding connectivity between the base station and a UPF, to an alarm confirmation device. The alarm confirmation device processes the received alert, identifies the reporting base station, and requests data for ongoing live session(s) corresponding to the base station. If the request response data indicates there is an ongoing session with successful communications status between the UPF and base station to which the received alert corresponds, the alarm confirmation device acts to suppress the alarm. If the request response indicates there are no ongoing sessions, then the alarm confirmation device attempts to establish a test communications session, between the base station and UPF, for a fake (e.g., non-existent) UE at the base station to which the alert corresponds and attempts to communicate dummy data. If the test communications session is successful, the alarm is suppressed.

### FIELD

The present application relates to communications methods and apparatus, and more particularly, to methods and apparatus for supporting more accurate alarm generation and notification regarding a link between a base station and user plane function (UPF).

### BACKGROUND

Several network entities come together and work together for a wireless network, e.g., a 5G Citizens Broadband Radio Servies (CBRS) network, to operate and operate properly. These entities could be various servers, applications etc. In order to keep the network up and running, operations must continue to monitor the network and investigate if there are any issues in the network.

Alarming is a key monitoring tool allowing operations to get an insight into the network and identify issues as they arise. There are various types of alarms, e.g., for software issues, hardware issues, connectivity and networking issues. These alarms are based on different protocols and messaging. However, they are usually collected in the same manner i.e., by the Operating Support System (OSS) or servers using Simple Network Management Protocol (SNMP) protocol.

One area of interest concerns issues of alarming with regard to base stations, e.g., gNBs, and user plane function (UPF). Alarming regarding gNB and UPF usually indicates that an end to end data communication between UE and UPF is interrupted, degraded or facing some type of degradation. There are several alarms, e.g., UPF disconnect, UPF fluctuation, and UPF link degradation. UPF disconnect alarm indicates the gNB is unable to contact UPF. UPF fluctuation alarm indicates that the link between the gNB and UPF is flappy, possibly causing degradation. UPF link degradation alarm indicates degradation due to backhaul issues, high packet loss or congestion, etc.

A gNB and UPF communicate over GTP (GPRS Tunneling Protocol) protocol, i.e., a tunnel is formed and data flows between use equipment (UE) and the UPF. GTP-U (user plane component of GTP) carries UE data, while also being responsible for alarming, i.e., connectivity between UPF and gNB. A gNB and UPF exchange UDP/IP (User Datagram Protocol/Internet Protocol) based echo request and response messages over a GTP-U tunnel for connectivity alerts.

Connectivity alerts between a gNB and UPF are managed using alarming logics, e.g., 5 echo messages missed in one minute means connectivity has been lost and an alarm should be generated. Lack of messages means there is a problem, i.e., the connectivity has been lost. Sometimes these messages are false because in a best effort network packet delivery UDP messages could also be queued at other network components such as server, routers, etc., and could be dropped. Another possibility is that protocols could put a lower priority on these packets and thus cause these packets to be lost. Due to these low priority packets getting lost/dropped, the network may experience alarms that are inaccurate, i.e., the site is online; however, due to dropped packets the system may raise an alarm that it is offline.

Based on the above discussion, there is a need for new methods and apparatus to determine if radio equipment has connectivity and to facilitate more accurate alarming. It would be advantageous if at least some of these new methods and apparatus reduce and/or eliminate false alarms.

### SUMMARY

Methods and apparatus, in accordance with the present invention, are directed to facilitating more accurate alarming regarding base station, e.g., gNB, to user plane function (UPF) connectivity. A base station generates and sends an alert of the risk of alarm generation to an alarm confirmation device. The alarm confirmation device processes the received alert, identifies the reporting base station, and requests, e.g., from an AMF, data for live session(s) corresponding to the base station. The alarm generation device receives and processes a request response. If the response indicates that an ongoing session with a link between the base station and user plane function (UPF) of interest, corresponding to the alert message, is active and is indicating successful communications, then the alarm generation device acts to suppress the alarm. If the response indicates that none of the ongoing session(s) with a link between the base station and user plane function (UPF) of interest, corresponding to the alert message, is active are indicating successful communications, then the alarm generation device acts to allow the alarm process to continue without suppression. If the response indicates that there are no ongoing sessions between the base station and user plane function (UPF) of interest, corresponding to the alert message, then the alarm generation device is operated to attempt to establish a communications session between the base station and UPF for a fake UE and initiate a test data flow of dummy data between the UPF and base station. The results of the attempted communications session establishment and test data flow are evaluated. If the results indicate successful communications for the test data flow, then the alarm confirmation device acts to suppress the alarm; otherwise, the alarm confirmation device act to allow the alarm process to continue with suppression.

A method of operating an alarm confirmation device, in accordance with some embodiments, comprises: receiving an alert indicating a risk of an alarm generation with regard to base station to User Plane Function (UPF) connectivity; identifying the base station to which the alert corresponds; requesting data from an access and mobility management function (AMF) for information regarding ongoing data sessions with UEs at the identified base station to which the alert corresponds; receiving the requested information regarding ongoing data sessions, the received requested information indicating whether at least one ongoing data session involving communication of data between the UPF and identified base station is ongoing and, when there is at least one ongoing data session, communications status information associated with the at least one ongoing data session; and determining if the received requested information regarding ongoing data sessions includes information for at least one ongoing data session; and when it is determined that the received requested information regarding ongoing data sessions indicates that at least one data session is ongoing, taking an action with regard to the alert based on the communication status of the at least one ongoing data session.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary communications system in accordance with an exemplary embodiment.

FIG. 2A is a first part of signaling diagram of an exemplary method of operating a communications system in accordance with an exemplary embodiment.

FIG. 2B is a second part of signaling diagram of an exemplary method of operating a communications system in accordance with an exemplary embodiment.

FIG. 2C is a third part of signaling diagram of an exemplary method of operating a communications system in accordance with an exemplary embodiment.

FIG. 2D is a fourth part of signaling diagram of an exemplary method of operating a communications system in accordance with an exemplary embodiment.

FIG. 2E is a fifth part of signaling diagram of an exemplary method of operating a communications system in accordance with an exemplary embodiment.

FIG. 2F is a sixth part of signaling diagram of an exemplary method of operating a communications system in accordance with an exemplary embodiment.

FIG. 2G is a seventh part of signaling diagram of an exemplary method of operating a communications system in accordance with an exemplary embodiment.

FIG. 2H is a eighth part of signaling diagram of an exemplary method of operating a communications system in accordance with an exemplary embodiment.

FIG. 2I is a ninth part of signaling diagram of an exemplary method of operating a communications system in accordance with an exemplary embodiment.

FIG. 2 comprises the combination of FIG. 2A, FIG. 2B, FIG. 2C, FIG. 2D, FIG. 2E, FIG. 2F, FIG. 2G, FIG. 2H and FIG. 2I.

FIG. 3 is a drawing of an exemplary alarm confirmation device, e.g., a real time alarming accuracy confirmation (RTAC) device, in accordance with an exemplary embodiment.

FIG. 4 is a drawing of an exemplary Operations Support System (OSS) device including a device and function interface and control (DAFIAC) module 112 in accordance with an exemplary embodiment.

FIG. 5 is a drawing of an exemplary base station, e.g., a gNB, in accordance with an exemplary embodiment.

FIG. 6 is a drawing of an exemplary core network device, e.g., a server, implementing one or more core network functions including a user plane function (UPF), in accordance with an exemplary embodiment.

FIG. 7 is a drawing of an exemplary core network device, e.g., a server, implementing one or more core network functions including an access and mobility management (AMF), in accordance with an exemplary embodiment.

### DETAILED DESCRIPTION

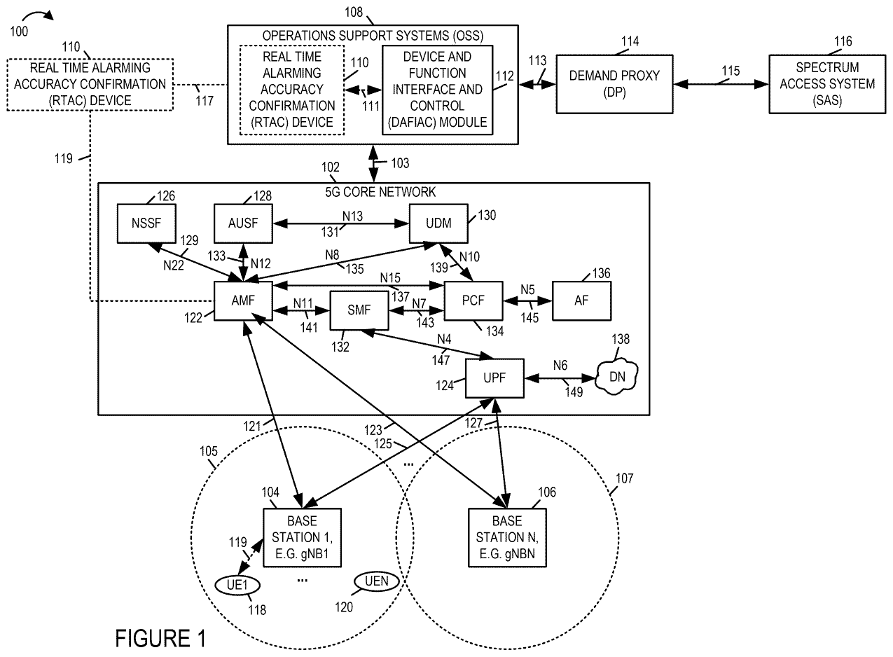

FIG. 1 is a drawing of an exemplary communications system 100 in accordance with an exemplary embodiment. Exemplary communications system 100 includes a 5G core network 102, a plurality of base stations (base station 1 104, e.g., gNB1, . . . , base station N 106, e.g., gNBN), an operations support system 108 including a device and function interface and control (DAFIAC) module 112, a real time alarming accuracy confirmation (RTAC) device 110, a demand proxy (DP) 114 and a Spectrum Access System (SAS) 116 coupled together as shown. In some embodiments, the RTAC device 110 is included as part of the Operations Support System (OSS) 108. In some other embodiments, the RTAC device 110 is external to the OSS 108, and the RTAC device 110 is coupled to the OSS 108.

5G core network 102 includes an access and mobility management function (AMF) 122, a user plane function (UPF) 124, a Network Slice Selection Function (NSSF) 126, an Authentication Server Function (AUSF) 128, a unified data management (UDM) 130, a session management function (SMF) 132, a policy control function (PCF) 134, an application function (AF) 136, and a data network (DN) 138 coupled together as shown. NSSF 126 is coupled to AMF 122 via N22 interface connection 129. AUSF 126 is coupled to AMF 122 via N12 interface connection 133. AUSF 128 is coupled to UDM 130 via N13 connection 131. AMF 122 is coupled to UDM 120 via N8 interface connection 135. AMF 122 is coupled to PCF 134 via N15 interface connection 137. AMF 122 is coupled to SMF 132 via N11 interface connection 141. SMF 132 is coupled to PCF 134 via N7 interface connection 143. SMF 132 is coupled to UPF 124 via N4 interface connection 147. PCF 134 is coupled to AF 136 via N5 interface 145. UPF 124 is coupled to DN 138 via N6 interface connection 149.

SAS 116 is coupled to DP 114 via communications link 115. DP 114 is coupled to OSS 108 via communications link 113. OSS 108 is coupled to 5C core network 102 via communications link 103. In some embodiments, in which RTAC device 110 is included as part of OSS 108, RTAC device 110 is coupled to DAFIAC module 112 via communications link 111. In some embodiments in which RTAC device 110 is located external to OSS 108, RTAC device 110 is coupled to OSS 108 via communications link 117, and RTAC device 110 is coupled to AMF 122 of 5G core network 103 via connection 119.

AMF 122 is coupled to base station 1 104 via connection 121. AMF 122 is coupled to base station N 106 via connection 123. UPF 124 is coupled to base station 1 104 via connection 125. UPF 124 is coupled to base station N 106 via connection 127.

Base station 1 104 has a corresponding wireless coverage area 105, and base station N 106 has a corresponding wireless coverage area 107. Exemplary communications system 100 further includes a plurality of user equipment (UE) devices (UE 1 118, . . . , UE N 120). At least some of the UEs are wireless communications devices, which may move throughout the communications system 100 and be connected to different base stations at different times.

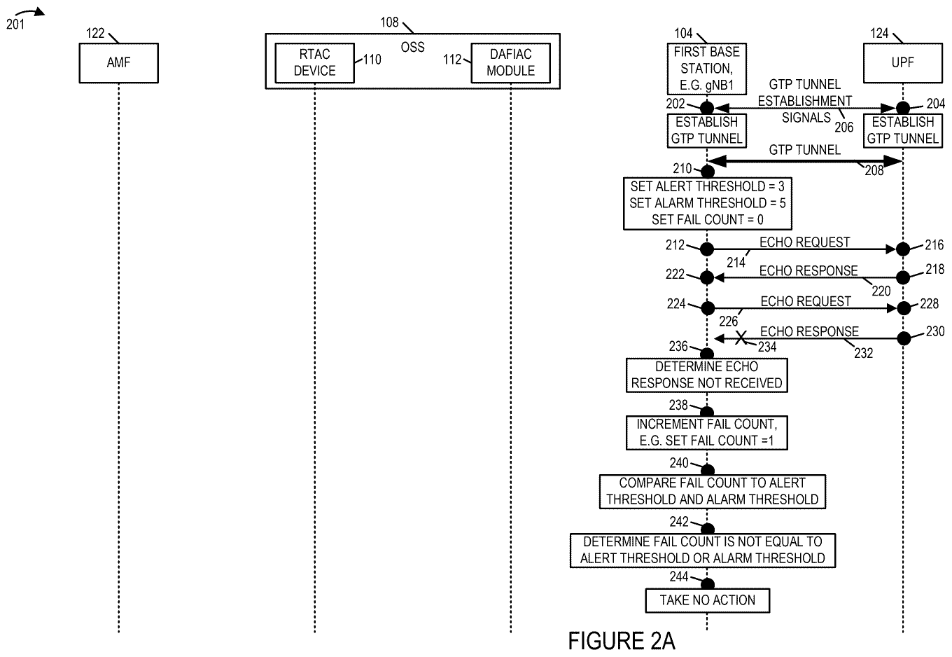

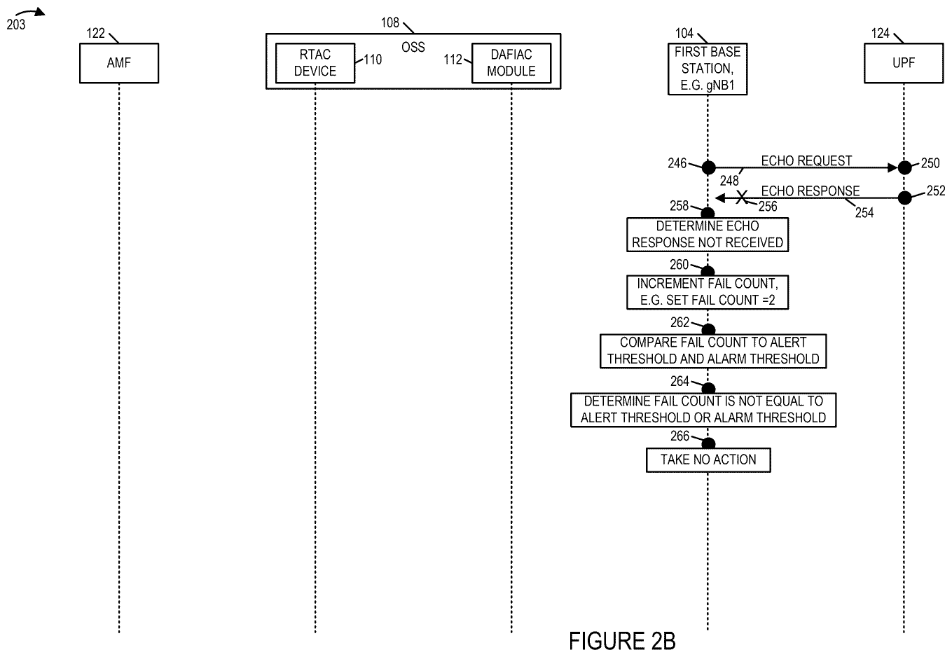

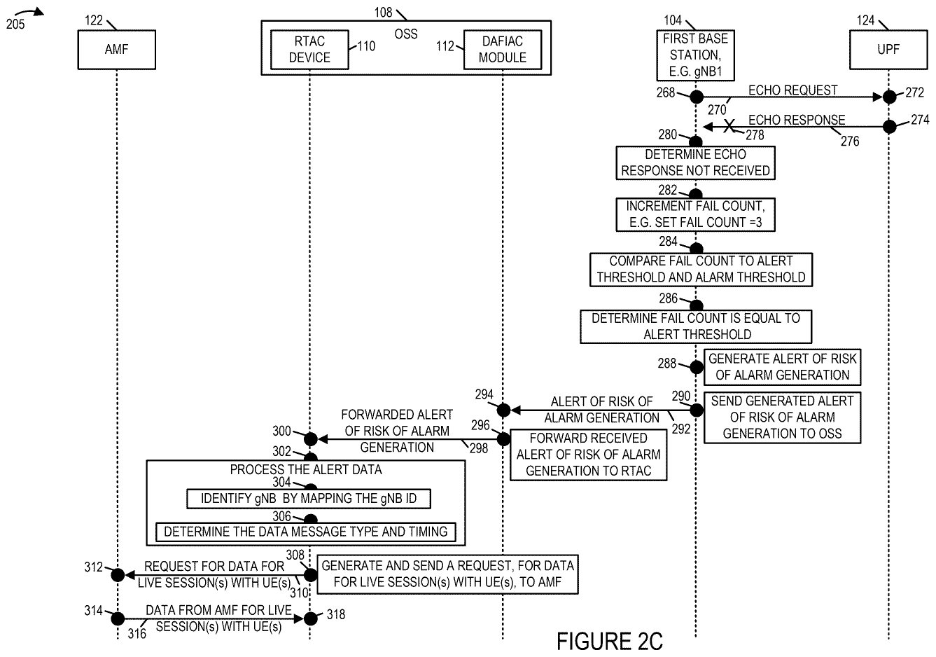

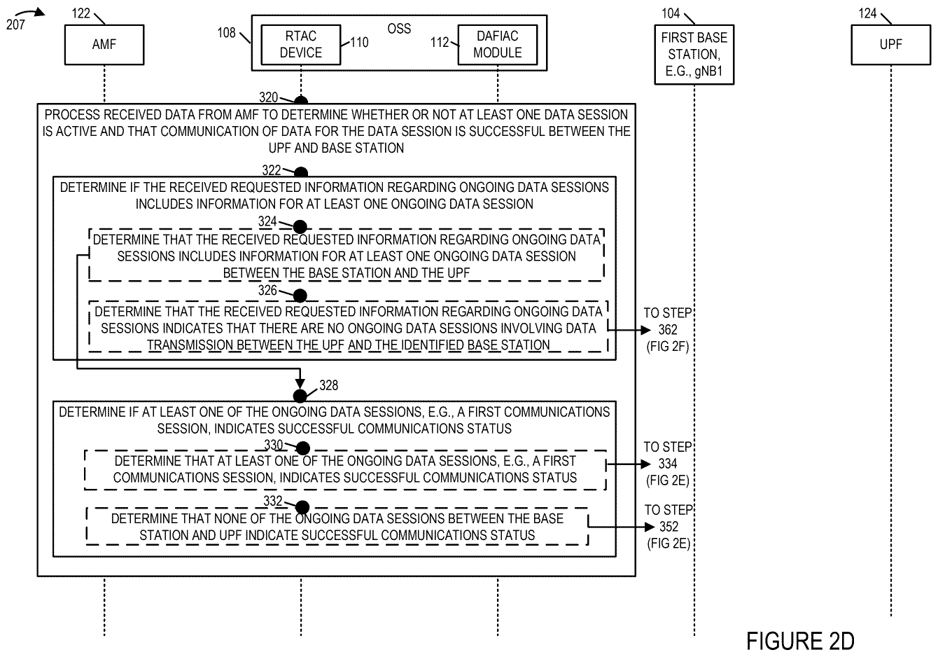

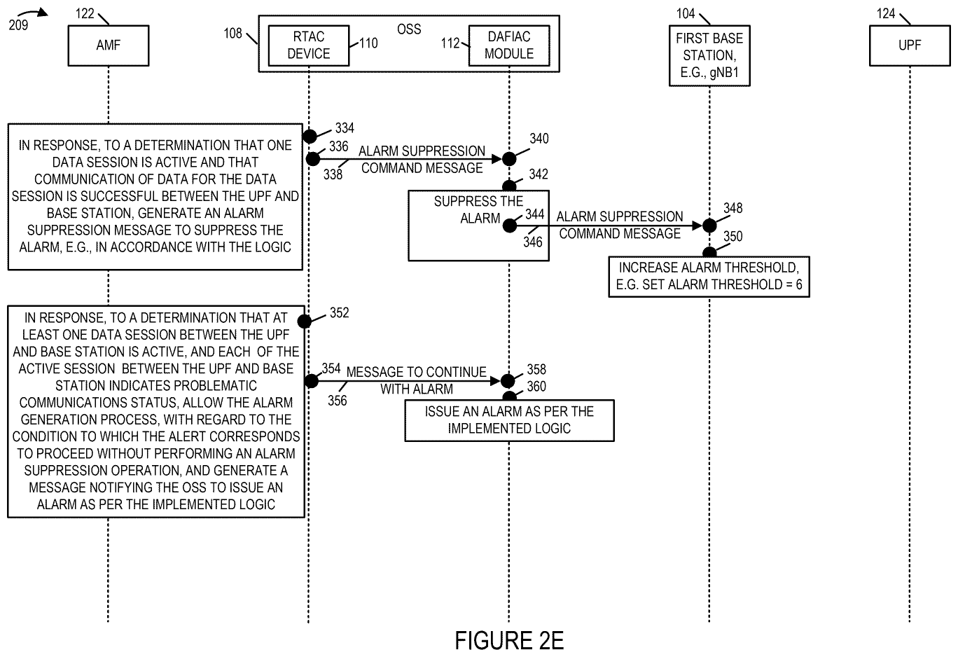

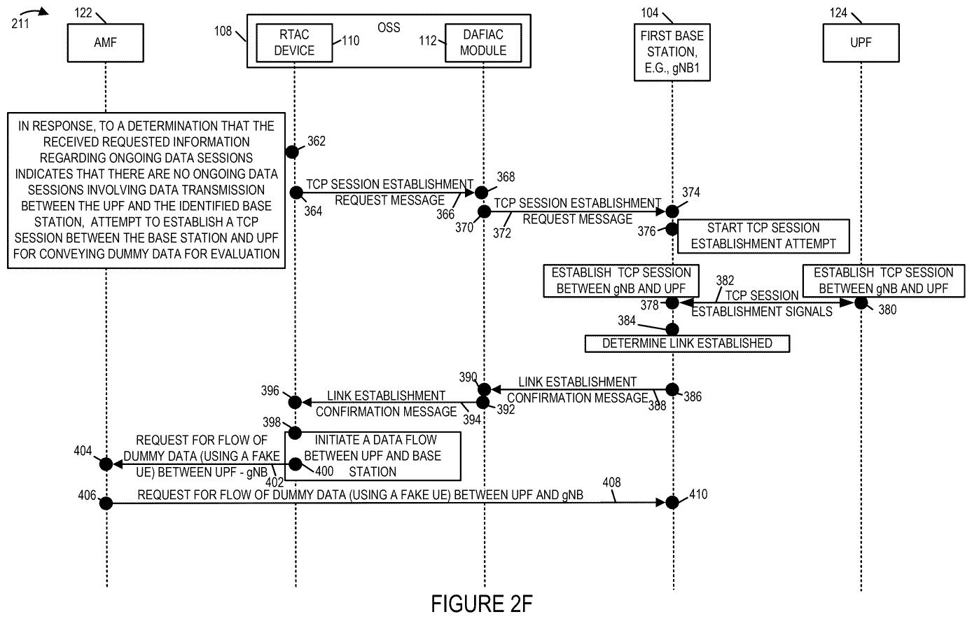

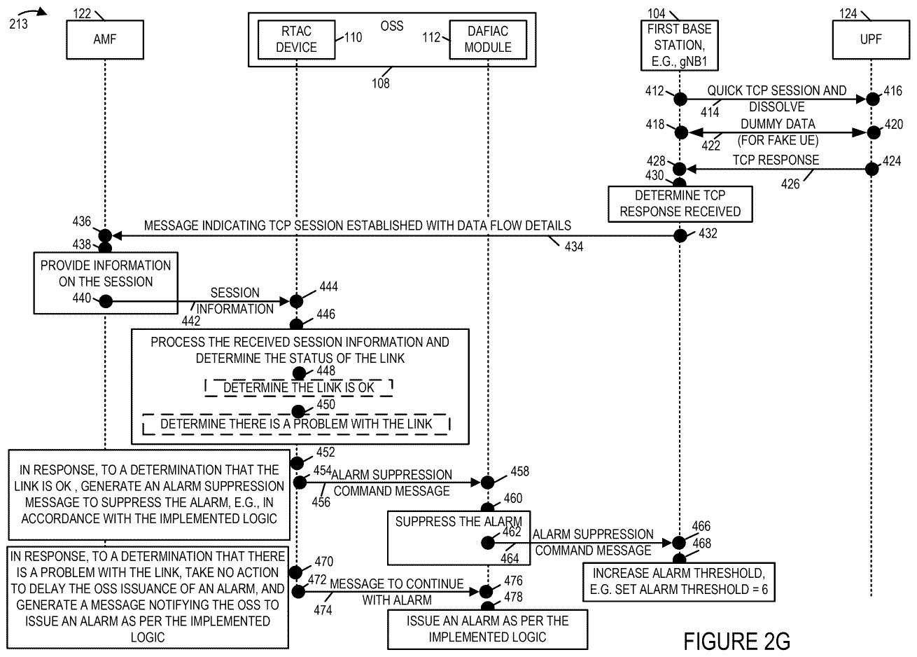

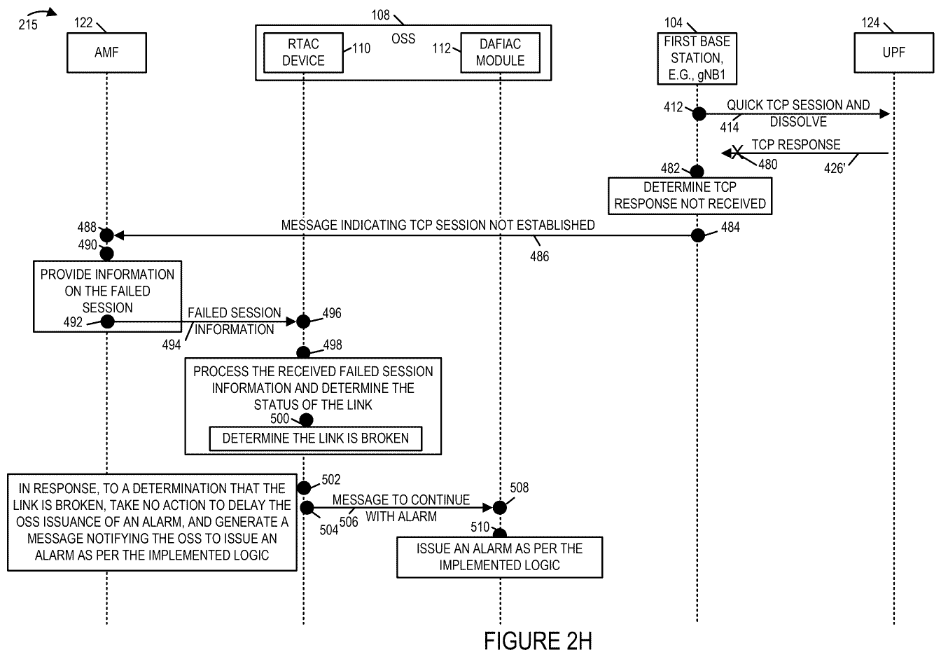

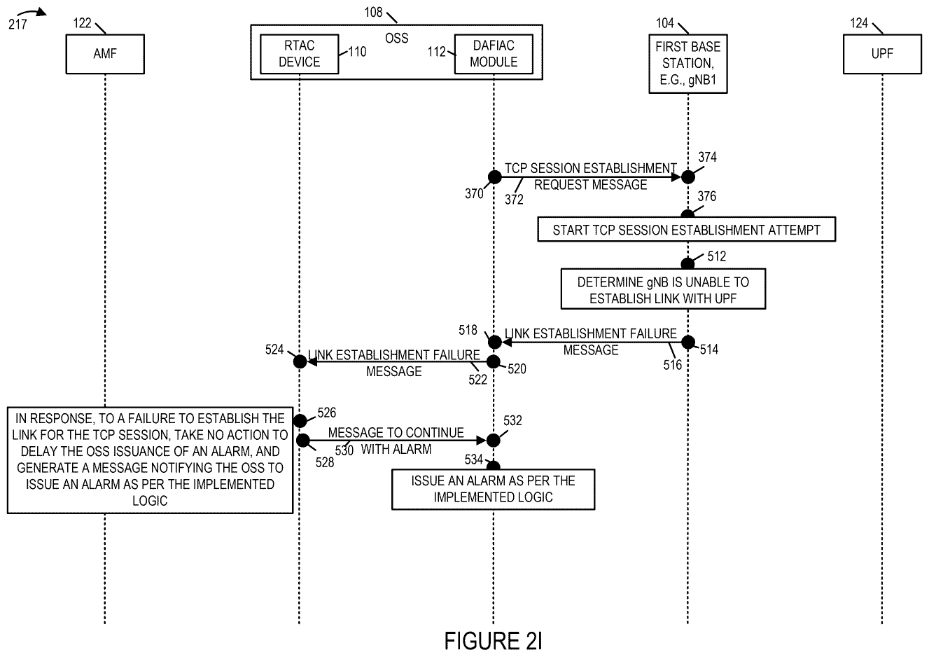

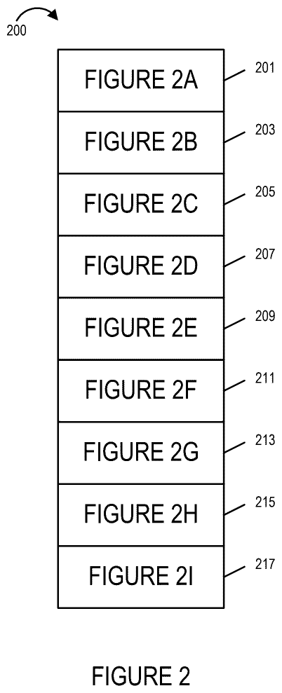

FIG. 2, comprising the combination of FIG. 2A, FIG. 2B, FIG. 2C, FIG. 2D, FIG. 2E, FIG. 2F, FIG. 2G, Figure H an Figure I, is a signaling diagram 200, comprising the combination of Part A 201, Part B 203, Part C 205, Part D 207, Part E 209, Part F 211, Part G 213, Part H 215 and Part I 217, of an exemplary method of operating a communications system, e.g., communications system 100 of FIG. 1, in accordance with an exemplary embodiment.

In steps 202 and 204, base station 104 and UPF 124 are operated, respectively to establish a GTP tunnel 208. In step 202 base station 104 is operated to send and receive GPT tunnel establishment signals 206. In step 204 UPF 124 is operated to receive and send GPT tunnel establishment signals 206.

In step 210 base station 104 performs initialization operations; base station sets alert threshold=3, sets alarm threshold=5, and sets fail count (e.g., echo response fail count)=0. In other embodiments, different initialization values may be, and sometimes are, used for the alert threshold and the alarm threshold.

In step 212 base station 104 generates and sends echo request 214 to UPF 124, which is received by UPF 124 in step 216. In step 218, UPF 124 generates and sends echo response 220 to base station 104. In step 222 base station receives and recovers echo response 220.

In step 224 base station 104 generates and sends echo request 226 to UPF 124, which is received by UPF 124 in step 228. In step 230, UPF 124 generates and sends echo response 232 to base station 104. Echo response 232 does not reach base station 104, as indicated by X 234, e.g., due to a communications problem or a failure condition. In step 236, base station 104 determines that an echo response was not received, e.g., within a predetermined expected time window, in response to previously communicated echo request 226. In step 238 the base station 104 increments fail count, e.g., sets fail count=1. In step 240 base station 104 compares the current value for fail count (1) to the alert threshold (3) and alarm threshold (5). In step 242 the base station 104 determines that the fail count is not equal to the alert threshold or alarm threshold. In response to the determination of step 242, the base station 104 takes no action.

In step 246 base station 104 generates and sends echo request 248 to UPF 124, which is received by UPF 124 in step 250. In step 252, UPF 124 generates and sends echo response 256 to base station 104. Echo response 254 does not reach base station 104, as indicated by X 256, e.g., due to a communications problem or a failure condition. In step 258, base station 104 determines that an echo response was not received, e.g., within a predetermined expected time window, in response to previously communicated echo request 248. In step 260 the base station 104 increments fail count, e.g., sets fail count=2. In step 262 base station 104 compares the current value for fail count (2) to the alert threshold (3) and alarm threshold (5). In step 264 the base station 104 determines that the fail count is not equal to the alert threshold or alarm threshold. In response to the determination of step 266, the base station 104 takes no action.

In step 268 base station 104 generates and sends echo request 270 to UPF 124, which is received by UPF 124 in step 272. In step 274, UPF 124 generates and sends echo response 276 to base station 104. Echo response 276 does not reach base station 104, as indicated by X 278, e.g., due to a communications problem or a failure condition. In step 280, base station 104 determines that an echo response was not received, e.g., within a predetermined expected time window, in response to previously communicated echo request 270. In step 282 the base station 104 increments fail count, e.g., sets fail count=3. In step 284 base station 104 compares the current value for fail count (3) to the alert threshold (3) and alarm threshold (5). In step 286 the base station 104 determines that the fail count is equal to the alert threshold.

In step 288, in response to the determination of step 280 that expected echo response 276 was not received and the determination of step 286 that the fail count equals the alarm threshold, the base station 104 generates an alert of the risk of alarm generation 292. In step 290 the base station 104 sends the generated alert of the risk of alarm generation 292 to DAFIAC module 112, which is received by DAFIAC module in step 294. In step 296, DAFIAC module 112 forwards the received alert of risk of alarm generation to RTAC device 110, as forwarded alert of risk of alarm generation message 298.

In step 300 RTAC device 110 receives message 298 and recovers the communicated alert of risk of alarm generation. In step 302 the RTAC device 110 processes the received alert data. Step 302 includes step 304 and step 306. In step 304 the RTAC device 110 identifies the base station, e.g. gNB, by mapping the base station identifier, e.g., gNB ID, e.g., RTAC device 110 recovers a base station identifier included in alert message 298 and identifies that the base station which corresponds to the alert is base station 104. In various embodiments, the alert message 298 also includes information identifying UPF 124, which corresponds to the alert, and the RTAC device also recovers the UPF 124 ID information. In step 306 the RTAC device 110 determines the data message type and timing.

In step 308 RTAC device 110 generates and sends a request 310 for data for live session(s), e.g., ongoing data sessions, with UE(s) corresponding to the identified base station, to AMF 122. In step 312, AMF 122 receives the request for data for live session(s) with UE(s). In response to the received request 310, in step 314 AMF 122 processes the request, e.g., retrieving requested data, and generates message 316, which includes data from the AMF 122 for live session(s) with UE(s), corresponding to the identified base station, and sends the generated message 316 to RTAC device 110. In step 318, RTAC device 110 receives message 316 and recovers the communicated data for live session, e.g., ongoing sessions, with UEs, corresponding to the identified base station.

In step 320, RTAC device 110 processes the received data from the AMF 122 to determine whether or not at least one data session is active and that communication of data for that data session is successful between UPF 124 and base station 104. Step 320 includes steps 322, 324, 326, 328, 330 and 332. In step 322 the RTAC device 110 determines if the received requested information regarding ongoing data sessions includes information for at least one ongoing data session.

Each iteration of step 322 includes one of step 324 and 326. In step 324 the RTAC device 110 determines that the received requested information regarding ongoing data sessions includes information for at least one ongoing data session between the base station 104 and UPF 124. Operation proceeds from step 324 to step 328. In step 326 RTAC device 110 determines that the received requested information regarding the ongoing data sessions indicates that there are no ongoing data session involving data transmission between the UPF 124 and the identified base station 104. Operation proceeds from step 326 to step 362 (of FIG. 2F).

Returning to step 328, in step 328, RTAC device 110 determines if at least one of the ongoing data sessions between the UPF 124 and base station 104, e.g., a first communications session, indicates successful communications status. Each iteration of step 328 includes one of step 330 and 332. In step 330 the RTAC device 110 determines that at least one of the ongoing communications sessions, e.g., a first communications session, indicates successful communications status. Operation proceeds from step 330 to step 334 (of FIG. 2E). In step 332 the RTAC device 110 determines that none of the ongoing communications sessions indicate successful communications status. Operation proceeds from step 332 to step 352 (of FIG. 2E).

In step 334, in response to a determination that one data session is active and that communications of data for the data session is successful between the UPF 124 and base station 104, as indicated by a received indicated communication successful status for the session, the RTAC device 110 generates an alarm suppression message 338 to suppress the alarm, corresponding to the received alert, e.g., in accordance with the implemented logic. In step 336, RTAC device 110 sends alarm suppression command message 338 to DAFIAC module 112, which receives the alarm suppression message 338 in step 340. In step 342 the DAFIAC module 112 is operated to suppress the alarm. Step 342 includes step 344 in which the DAFIAC generates and sends an alarm suppression command message 346 to base station 104, which is received by base station 104 in step 348. In step 350, base station 104, in response to the received alarm command message, is operated to suppress the alarm. In this exemplary embodiment, in step 350 the base station 104 increase the alarm threshold, e.g., base station 104 set alarm threshold=6. In another exemplary embodiment, a different type of alarm suppression operation is performed in step 350, e.g., the alarm suppression operation of step 350 includes reducing the fail count (e.g., echo response fail count) or setting the fail count=0. In another exemplary embodiment, the alarm suppression operation includes stopping incrementing the fail count (e.g., echo response fail count) for a predetermined amount of time.

In step 352, in response to a determination that at least one data session between the UPF 124 and base station 104 is active and each of the active sessions between the UPF 124 and base station 104 indicates problematic communications status, the RTAC device 110 is operated to allow the alarm generation process, with regard to the condition to which the alert corresponds, to continue without performing an alarm suppression operation, and the RTAC device 110 generates a message notifying the OSS, e.g., the DAFIAC module 112 in the OSS 108, to issue an alarm as per the implemented logic. In step 354 RTAC device 110 generates and sends message to continue with alarm (no suppression) 356 to DAFIAC module 112, which is received by DAFIAC module 112 in step 358. In step 360, DAFIAC module 112 issues an alarm as per the implemented logic.

In step 362, in response to a determination that the received requested information regarding the ongoing data sessions indicates that there are no ongoing data sessions involving data transmission between the UPF 124 and the identified base station 104, the RTAC device 110 attempts to establish a Transmission Control Protocol (TCP) session between the base station 104 and the UPF 124 to be used for conveying dummy data for evaluation. In step 364 RTAC device 110 generates and sends a TCP session establishment request message 366 to DAFIAC module 112, which receives message 366 in step 368. In step 370, DAFIAC module 112 generates and sends TCP session establishment request message 372, e.g., a forwarded copy of message 366, to base station 104, which receives message 372 in step 374. In step 376, in response to the received TCP session establishment request message 372, base station 104 starts a TCP session establishment attempt. In step 378 base station 104 is operated to establish a TCP session with UPF 124, said operations including communicating TCP session establishment signals 382. In step 380 UPF 124 is operated to establish a TCP session with base station 104, said operations including communicating TCP session establishment signals 382. In step 384 base station 104 determines that a link has been established for the TCP session, and in step 386, base station 104 generates and sends link establishment confirmation message 388 to DAFIAC 112, which receives message 388, in step 390. In step 392 the DAIFAC module 112 generates and sends link establishment confirmation message 394, e.g., a forwarded copy of message 388, to RTAC device 110, which receives the link establishment confirmation message 394 in step 396.

In response to the received link establishment confirmation message 394, in step 398, RTAC device 110 initiates a data flow between UPF 124 and base station 104. Step 398 includes step 400 in which the RTAC device 110 generates and sends, to AMF 122, a request 402 for flow of dummy data (using a fake UE) between the UPF 124 and the base station 104. In step 404 AMF 122 receives the request 402, and in step 406 AMF generates and sends a request 408 for flow of dummy data (using a fake UE) between UPF 124 and base station 104. In some embodiments, message 408 is a forwarded copy of message 402. In step 410 base station 104 receives the request 408 for flow of dummy data (using a fake UE) between UPF 124 and base station 104.

In step 412, base station sends signals 414 to UPF 124 for a quick TCP session and dissolve. In step 416, UPF 124 receives signals 414, and recovers the communicated information. In step 418 and step 420 the base station 104 and UPF 124, respectively, are operated to communicate dummy data 422, for a fake UE, as part of the quick TCP session. In step 424 UPF 124 generates and sends a TCP response message 426 to base station 104, which, in step 428 receives the TCP response message 426 and recovers the communicated information. In step 430 base station 104, determines that a TCP response message 426 has been received indicating the TCP session was established, data (dummy data was communicated) and that data flow details have been provided by the UPF 124 to the base station 104. In step 432 base station 104 generates and sends message 434 to AMF 122 indicating TCP session established with data flow details. In step 436, AMF 122 receives message 434 and recovers the communicated information. In step 438 AMF 122 is operated to provide information on the communications session to the RTAC device 110. Step 438 includes step 440, in which AMF 122 generates and sends session information message 442 to RTAC device 110, which receives message 442 in step 444 and recovers the communicated information.

In step 446 the RTAC device 110 processes the received session information and determines the status of the link. Each iteration of step 446 includes one or step 448 or step 450. In step 448 the RTAC device 110 determines the link is ok. Operation proceeds from step 448 to step 452. Alternatively, in step 450 the RTAC device 110 determines that there is a problem with the link. Operation proceeds from step 450 to step 470.

Returning to step 452, in step 452, in response to a determination that the link is ok, the RTAC device 110 generates an alarm suppression message 456 to suppress the alarm, e.g., in accordance with the implemented logic. Operation proceeds from step 452 to step 454, in which the RTAC device 110 sends the generated alarm suppression command message 456 to the DAFIAC 112, which receives message 456 in step 458. In step 460 the DAFIAC module 112 suppresses the alarm. Step 460 includes step 462 in which the DAFIAC module 112 generates and sends an alarm suppression command message 464 to base station 104, which is received by base station 104 in step 466. In step 468, base station 104, in response to the received alarm command message, is operated to suppress the alarm. In this exemplary embodiment, in step 468 the base station 104 increases the alarm threshold, e.g., base station 104 sets alarm threshold=6. In another exemplary embodiment, a different type of alarm suppression operation is performed in step 468, e.g., the alarm suppression operation of step 468 includes reducing the fail count (e.g., echo response fail count) or setting the fail count=0. In another exemplary embodiment, the alarm suppression operation includes stopping incrementing the fail count (e.g., echo response fail count) for a predetermined amount of time.

Returning to step 470, in step 470, in response to a determination that there is a problem with the link, the RTAC device 110 the RTAC takes not action to delay the OSS issuance of an alarm and generates a message 474 notifying the OSS, e.g. notifying the DAFIAC 112 of the OSS 108, to issue an alarm per the implemented logic. Operation proceeds from step 470 to step 472, in which the RTAC device 110 sends the message 474 notifying the OSS to continue with the alarm (no delay) to the DAFIAC 112, which receives message 474 in step 476. In step 478 the DAFIAC module 112 issues an alarm as per the implemented logic.

FIG. 2H illustrates an alternative flow to FIG. 2G, for the case in which the TCP session is not successfully established and dummy data, for a fake UE, is not successfully communicated over a link between the base station 104 and UPF 124. In step 412, base station sends signals 414 to UPF 124 for a quick TCP session and dissolve. In this example, the TCP session is not successfully established, and thus a TCP response message 426′ is not communicated from UPF 124 to base station 104, as indicated by X 480.

In step 482 base station 104, determines that a TCP response message has been received. In step 484 base station 104 generates and sends message 486 to AMF 122 indicating TCP session was not established. In step 488, AMF 122 receives message 486 and recovers the communicated information, indicating that the TCP session was not established. In step 490 AMF 122 is operated to provide information on the failed communications session to the RTAC device 110. Step 490 includes step 492, in which AMF 122 generates and sends failed session information message 494 to RTAC device 110, which receives message 494 in step 496 and recovers the communicated information. In step 498 RTAC device 110 processes the received failed session information and determines the status of the link. Step 498 includes step 500, in which the RTAC device 110 determines the link (between UPF 124 and base station 104) is broken. Operation proceeds from step 500 to step 502.

In step 502, in response to a determination that the link is broken, the RTAC device 110 is operated to take no action to delay the OSS issuance of an alarm, and the RTAC device 110 generates a message 506 notifying the OSS, e.g. notifying the DAFIAC module 112 of the OSS 108, to issue an alarm per the implemented logic. Operation proceeds from step 502 to step 504, in which the RTAC device 110 sends message 506, notifying the OSS to continue with the alarm, to DAFIAC 112, which receives message 506 in step 508. In step 510, DAFIAC module 112 issues an alarm as per the implemented logic.

FIG. 2I illustrates an alternative to signaling flow shown of FIG. 2F, for a case in which the TCP session establishment attempt started in step 376 is not successful.

In step 370 DAFIAC module 112 generates and sends TCP session establishment request message 372 to base station 104, which receives message 372 in step 374. In step 376, base station 104 starts a TCP session establishment attempt to establish a TCP with UPF 124, said TCP session, if successfully established to be used to communicate dummy data, for a fake UE, between UPF 124 and base station 104, to evaluate the status of the link.

In this exemplary scenario, the TCP session establishment attempt is unsuccessful, and in step 512 base station 104 determines the base station 104 is unable to establish a link with UPF 124. In step 514 base station 104 generates and sends a link establishment failure message 516 to DAFIAC module 112, which is received by DAFIAC module 112 in step 518. In step 520 DAFIAC module 112 generates and sends link establishment failure message 522 to RTAC device 110, which receives message 522 in step 524 and recovers the communicated information. In step 526, in response to a failure to establish the link for the TCP session, the RTAC device 110 is operated to take no action to delay the OSS issuance of an alarm, and the RTAC device 110 generates a message 530 notifying the OSS, e.g. notifying the DAFIAC module 112 of the OSS 108, to issue an alarm per the implemented logic. Operation proceeds from step 526 to step 528, in which the RTAC device 110 sends message 530, notifying the OSS to continue with the alarm, to DAFIAC 112, which receives message 530 in step 532. In step 534, DAFIAC module 112 issues an alarm as per the implemented logic.

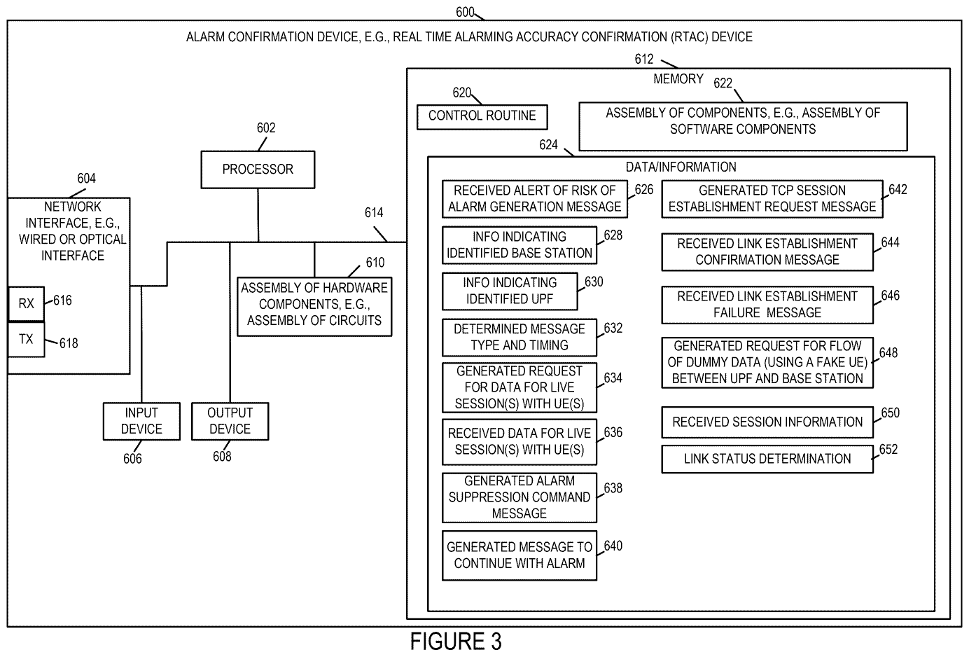

FIG. 3 is a drawing of an exemplary alarm confirmation device 600, e.g., a real time alarming accuracy confirmation (RTAC) device, in accordance with an exemplary embodiment. Alarm confirmation device 600 is, e.g., RTAC device 110 of FIGS. 1-2. Exemplary alarm confirmation device 600 includes a processor 602, e.g., a CPU, a network interface 604, an input device 606, e.g., a keyboard, an output device 608, e.g., a display, an assembly of hardware components 610, e.g., an assembly of circuits, and memory 612 coupled together via a bus 614 over which the various elements may interchange data and information.

Network interface 604, e.g., a wired or optical interface, includes a receiver 616 and a transmitter 618. Network interface 604 couples the alarm confirmation device 600 to OSS devices, e.g., an OSS device including a DAFIAC module, core network node devices, e.g., a server implementing an AMF, to network nodes and/or the Internet.

Memory 612 includes a control routine 620, an assembly of components 622, and data/information 624. Control routine 620 includes instructions, which when executed by processor 602 control the alarm confirmation device 600 to perform basic device operational functions such as, e.g., controlling the network interface 604, controlling input device 606, controlling output device 608, accessing memory 612, storing in memory 612, etc. Assembly of components 622, e.g., an assembly of software components, includes instructions, which when executed by processor 602 control the alarm confirmation device 600 to implement steps of a method, e.g., steps of the method of signaling diagram 200 of FIG. 2, which are implemented by RTAC device 110.

Data/information 624 includes a received alert of risk of alarm generation message 626, information 628 indicating the identified base station corresponding to the received alert, information 630 identifying the UPF corresponding to the alert, information 632 identifying the determined message type and timing corresponding the received alert, a generated request message 634 requesting data for live session(s) with UE(s) corresponding to the identified base station corresponding to the received alert, said generated request message 634 to be sent to an AMF, and received data 634 for live session(s) with UE(s) corresponding to the identified base station, said received data 634 being sent from the AMF. Data/information 624 further includes a generated alarm suppression command message 638, e.g., to be sent to a DAFIAC in OSS, a generated message 640 indicating to continue with alarm, e.g., to be sent to a DAFIAC in OSS, a generated TCP session establishment request message 642, e.g., to be sent to DAFIAC for forwarding to a base station, a received link establishment confirmation message 644, a received link establishment failure message 646, a generated request 648 for flow of dummy data (using a fake UE) between UPF and base station, e.g., to be sent to an AMF for forwarding to a base station, received session establishment information 650 and a link status determination 52.

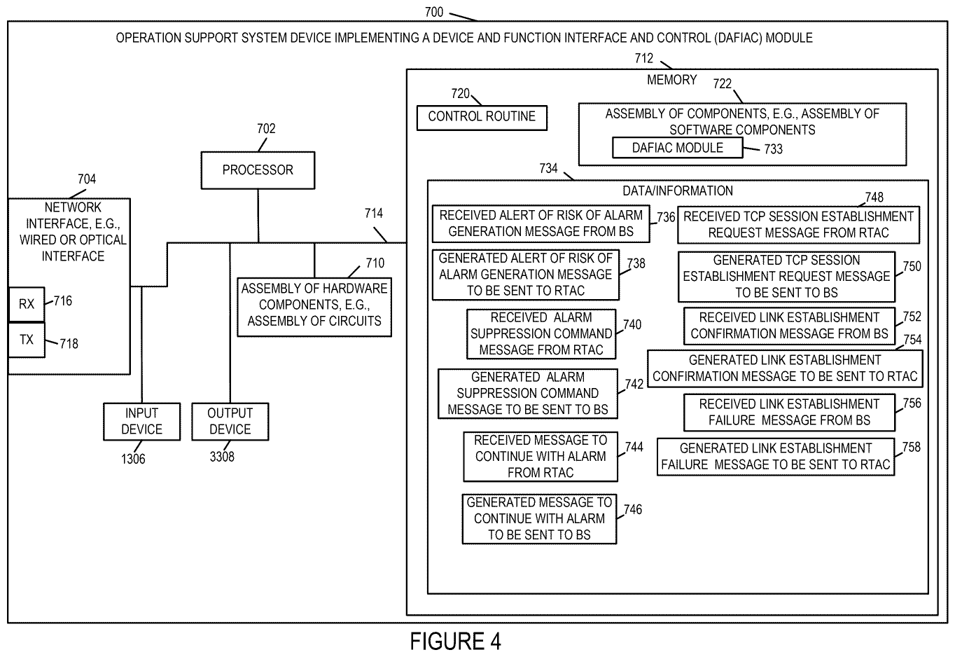

FIG. 4 is a drawing of an exemplary Operations Support System (OSS) device 700 including a device and function interface and control (DAFIAC) module in accordance with an exemplary embodiment. OSS device 700 is, e.g., a device including DAFIAC module 112 of FIGS. 1-2. OSS device 700 includes a processor 702, e.g., a CPU, a network interface 704, an input device 706, e.g., a keyboard, an output device 708, e.g., a display, an assembly of hardware components 710, e.g., an assembly of circuits, and memory 712 coupled together via a bus 714 over which the various elements may interchange data and information.

Network interface 704, e.g., a wired or optical interface, includes a receiver 716 and a transmitter 718. Network interface 704 couples the OSS device 700 to an alarm confirmation device, e.g., RTAC device 110, base station, e.g., base station 104, core network node devices, e.g., a server implementing an AMF, to network nodes, to a demand proxy, and/or the Internet.

Memory 712 includes a control routine 720, an assembly of components 722, and data/information 734. Control routine 720 includes instructions, which when executed by processor 702 control the OSS device 700 to perform basic device operational functions such as, e.g., controlling the network interface 704, controlling input device 706, controlling output device 708, accessing memory 712, storing in memory 712, etc. Assembly of components 722 includes a DAFIAC module 723, e.g., DAFIAC module 112. Assembly of components 722, e.g., an assembly of software components, includes instructions, which when executed by processor 702 control the OSS device 700 to implement steps of a method, e.g., steps of the method of signaling diagram 200 of FIG. 2, which are implemented by DAFIAC module 112.

Data/information 734 includes a received alert of alarm generation message 736 from a base station, a generated alert of risk of alarm generation message 738, to be sent to RTAC. In some embodiments, generated alert message 738 is a forwarded copy of received alert message 736. Data/information 734 further includes a received alarm suppression command message 740 from RTAC, and a generated alarm suppression command message 742 to be sent to a base station. In some embodiments, generated alarm suppression message 742 is a forwarded copy of received alarm suppression message 740. Data/information 734 further includes a received message 744 indicating to continue with alarm from RTAC, and a generated message 746 indicating to continue with alarm to be sent to a base station. In some embodiments, generated alarm continue message 746 is a forwarded copy of received alarm continue message 744. Data/information 734 further includes a received TCP session establishment request message 748 from RTAC and a generated TCP session establishment request message 750 to be sent to a base station, a received link establishment confirmation message 752 from a base station, a generated link establishment confirmation message 754 to be sent to RTAC, a received link establishment failure message 756 from a base station and a generated link establishment failure message 758 to be sent to RTAC.

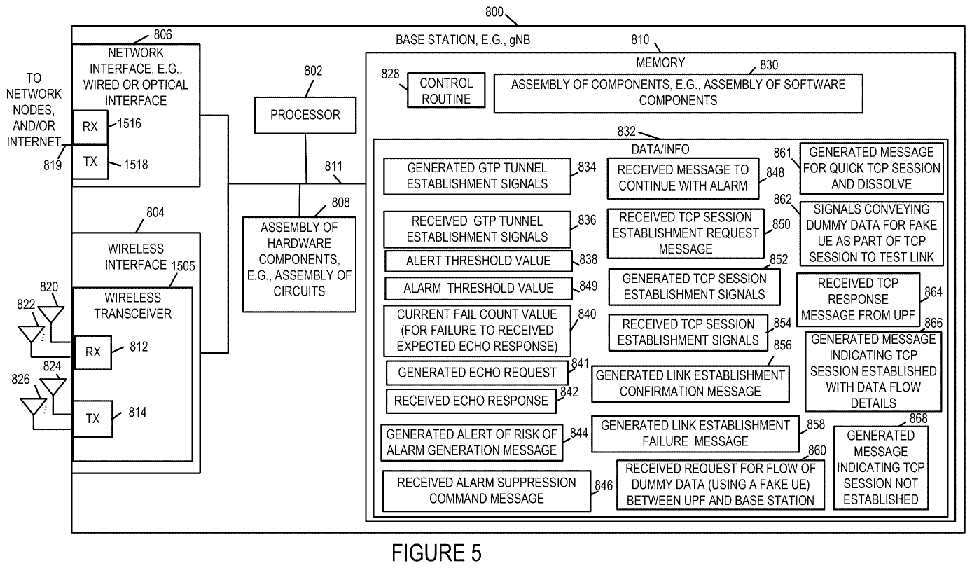

FIG. 5 is a drawing of an exemplary base station 800, e.g., a gNB, in accordance with an exemplary embodiment. In some embodiments base station 800 is a CBRS base station. Base station 800 is, e.g., base station 1 104, e.g., gNB 1, of FIGS. 1-2. Exemplary base station 800 includes a processor 802, e.g., a CPU, a wireless interface 804, a network interface 806, an assembly of hardware components 808, e.g., an assembly of components, and a memory 810 coupled together via a bus 811 over which the various elements may interchange data and information. Wireless interface 804 includes a wireless receiver 812 coupled to one or more receive antennas (820, . . . 822) and a wireless transmitter 814 coupled to one or more transmit antennas (824, . . . , 826). In some embodiments the wireless receiver 812 and wireless transmitter 814 are included as part of a transceiver 805, e.g., a transceiver chip.

Network interface 806, e.g., a wired or optical interface, includes a receiver 816 and a transmitter 818 coupled to an interface connector 819, which couples the base station 800 to network nodes including, and/or the Internet. Memory 810 includes a control routine 828, an assembly of components 830, e.g., an assembly of software components, and data/information 832. Control routine 828 includes instructions, which when executed by processor 802 control the base station 800 to perform basic device operational functions such as, e.g., controlling the network interface 806, accessing memory 810, storing in memory 810, etc. Assembly of components 830, e.g., an assembly of software components, includes instructions, which when executed by processor 802 control the base station 800 to implement steps of a method, e.g., steps of the method of signaling diagram 200 of FIG. 2, which are implemented by base station 104.

Data/information 832 includes generated GTP tunnel establishment signals 834, received GTP tunnel establishment signals, an alert threshold value 838, an alarm threshold value 849, a current fail count value 840, e.g., a count of failures to received expected echo responses, a generated echo request 840 to be sent to a UPF, a received echo response 842 from a UPF, a generated alert of risk of alarm generation message 844, a received alarm suppression command message 846, a received message 848 indicating to continue with alarm, a received TCP session establishment request message 850, generated TCP session establishment signals 854, received TCP session establishment signals 856, a generated link establishment failure message 858, a received request message 860 for flow of dummy data (using a fake UE) between UPF and the base station, a generated message 861, to be communicated to UPF, said generated message 861 for establishing a quick TCP session including the communication of dummy data for a fake UE and dissolve, signals 862 conveying dummy data for the fake UE as part of the quick TCP session to test the link between the base station and UPF, a received TCP response message 864 from the UPF, conveying information related to the quick TCP session which tested the link, a generated message 866 indicating TCP session established and further including data flow details, and a generated message 868 indicating the quick TCP session was not established, e.g., due to a broken link between the base station and UPF.

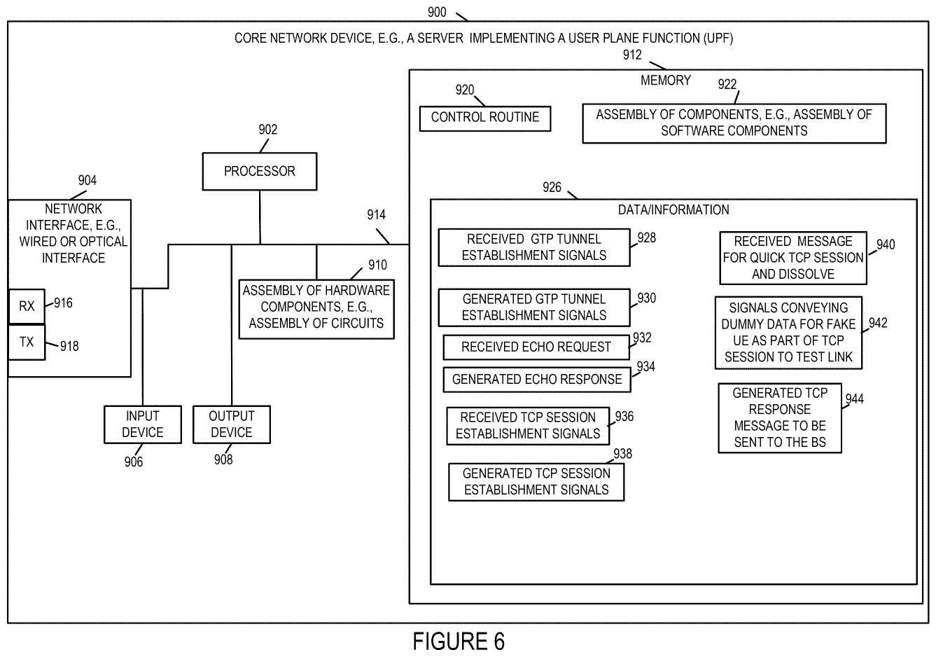

FIG. 6 is a drawing of an exemplary core network device 900, e.g., a server, implementing a user plane function (UPF), in accordance with an exemplary embodiment. Core network device 900 is, e.g., a device implementing UPF 124 of FIGS. 1-2. Exemplary core network device 900 includes a processor 902, e.g., a CPU, a network interface 904, an input device 906, e.g., a keyboard, an output device 908, e.g., a display, an assembly of hardware components 910, e.g., an assembly of circuits, and memory 912 coupled together via a bus 914 over which the various elements may interchange data and information.

Network interface 904, e.g., a wired or optical interface, includes a receiver 916 and a transmitter 918. Network interface 904 couples the core network device 900 to base stations, e.g. base station 104, OSS devices, e.g., an OSS device including a DAFIAC module, a RTAC device, other core network node devices, e.g., a server implementing an AMF, to network nodes and/or the Internet.

Memory 912 includes a control routine 920, an assembly of components 922, and data/information 924. Control routine 920 includes instructions, which when executed by processor 902 control the core network device 900 to perform basic device operational functions such as, e.g., controlling the network interface 904, controlling input device 906, controlling output device 908, accessing memory 912, storing in memory 912, etc. Assembly of components 922, e.g., an assembly of software components, includes instructions, which when executed by processor 902 control the core network device 900 to implement steps of a method, e.g., steps of the method of signaling diagram 200 of FIG. 2, which are implemented by UPF 124.

Data/information 926 includes received GTP tunnel establishment signals 928, generated GTP tunnel establishment signals 930, a received echo request message 932 from a base station, a generated echo response message 934 to be sent to the base station, received TCP session establishment signals 936, generated TCP session establishment signals 938, a received message 940 for a quick TCP session and dissolve, signals 942 conveying dummy data as part of the TCP session to test the link between the UPF and the base station, and a generated TCP response message 944 to be sent to the base station following completion of the quick TCP session.

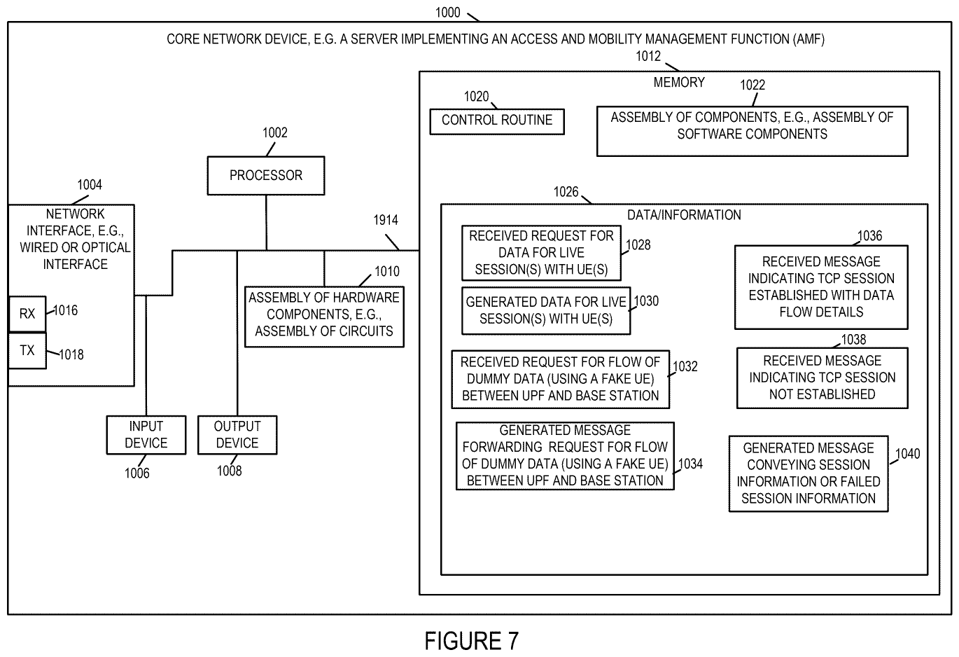

FIG. 7 is a drawing of an exemplary core network device 1000, e.g., a server, implementing an access and mobility management (AMF), in accordance with an exemplary embodiment. Core network device 1000 is, e.g., a device implementing AMF 122 of FIGS. 1-2. Exemplary core network device 1000 includes a processor 1002, e.g., a CPU, a network interface 1004, an input device 1006, e.g., a keyboard, an output device 1008, e.g., a display, an assembly of hardware components 1010, e.g., an assembly of circuits, and memory 1012 coupled together via a bus 1014 over which the various elements may interchange data and information.

Network interface 1004, e.g., a wired or optical interface, includes a receiver 1016 and a transmitter 1018. Network interface 1004 couples the core network device 1000 to base stations, e.g. base station 104, OSS devices, e.g., an OSS device including a DAFIAC module, a RTAC device, other core network node devices, e.g., a server implementing a UPF, to network nodes and/or the Internet.

Memory 1012 includes a control routine 1020, an assembly of components 1022, and data/information 1024. Control routine 1020 includes instructions, which when executed by processor 1002 control the core network device 1000 to perform basic device operational functions such as, e.g., controlling the network interface 1004, controlling input device 1006, controlling output device 1008, accessing memory 1012, storing in memory 1012, etc. Assembly of components 1022, e.g., an assembly of software components, includes instructions, which when executed by processor 1002 control the core network device 1000 to implement steps of a method, e.g., steps of the method of signaling diagram 200 of FIG. 2, which are implemented by AMF 122.

Data/information 1026 includes a received request 1029 for data for live session(s) with UE(s) corresponding to a base station, which has sent an alert message indicating a risk of alarm generation, generated data 1030 for live session(s) with UE(s), communicating the requested data indicated in received request message 1028, a received request 1032, e.g., from a RTAC, for a flow of dummy data (using a fake UE) between UPF and base station, and a generated message 1034 forwarding the received request for flow of dummy data (using a fake UE) between UPF and base station, said generated message 1034 to be sent to the base station. Data/information 1026 further includes a received message 1036 indicating TCP session established with data flow details, a received message 1038 indicating TCP session not established, and a generated message 1040, to be sent to a RTAC, said generated message 1040 conveying session information or failed session information, e.g., to be used by the RTAC in making decisions as to whether to suppress an alarm or allow an alarm to continue without suppression.

### NUMBERED LIST OF EXEMPLARY METHOD EMBODIMENTS

Method Embodiment 1. A method of operating an alarm confirmation device (110) (e.g. a real time alarming accuracy confirmation (RTAC) device (110)) (which in some embodiments is part of an operations support system (108) which includes a device and function interface and control (DAFIAC) module (112) which may include one or more interfaces and/or functions), the method comprising: receiving (300) an alert (e.g., an indication that an echo response was not received by a base station (e.g., base station 1 (104), e.g. gNB 1), which in some cases is received (294) by the OSS DAFIAC module (112) and forwarded (296) to the RTAC (110)) indicating a risk of an alarm generation with regard to base station (e.g., gNB) to User Plane Function (UPF) connectivity; identifying (304) the base station (104) to which the alert corresponds; requesting (308) data from an access and mobility management function (AMF) (122) for information regarding ongoing (e.g., live) data sessions with UEs at the identified base station (104) to which the alert corresponds (e.g., whether there are one or more live data sessions involving communication of data between the UPF (122) and identified base station (104) to which the alert corresponds); receiving (318) the requested information regarding ongoing data sessions, the received requested information indicating whether at least one ongoing data session involving communication of data between the UPF and identified base station is ongoing and, when there is at least one ongoing data session, communications status information (e.g., whether the data communications is successful or problematic where problematic may and sometimes does include one or more of failed communications, dropped packets above a threshold or delays in data above an acceptable threshold) associated with the at least one ongoing data session; determining (322) if the received requested information regarding ongoing data sessions includes information for at least one ongoing data session; and when it is determined that (324) the received requested information regarding ongoing data sessions indicates that at least one data session is ongoing, taking an action (334, 336 or 352, 354) with regard to the alert based on the communication status of the at least one ongoing data session.

Method Embodiment 2. The method of Method Embodiment 1, wherein it is determined that (324) the received requested information includes information for at least one ongoing data session, said at least one ongoing data session being a first ongoing data session corresponding to a first UE receiving service from the identified base station; wherein the communications status information associated the first communications session indicates successful communications status (330); and wherein the method further includes suppressing (334, 336) a possible alarm corresponding to the received alert (e.g., an alarm associated with the alert condition such as a communications failure alarm due to missing echo responses in a predetermined time period, e.g., 1 minute, the suppression operation may and sometimes does involve reset (e.g., lowering) a count of missed echo responses to a lower number, e.g., zero, or increasing an alarm threshold value (e.g., where the threshold number of missed echo responses needs to be missed in a predetermined time period/alarm window for an alarm to be generated), or prohibiting an alert corresponding to missed echo responses for a predetermined period of time).

Method Embodiment 2A. The method of Method Embodiment 1, wherein it is determined that (324) the received requested information includes information for at least one ongoing data session, said at least one ongoing data session being a first ongoing data session corresponding to a first UE receiving service from the identified base station; wherein the communications status information associated the first communications session indicates a problematic communications status (332); and wherein the method further includes allowing (352) the alarm generation process with regard to the condition to which the alert corresponds to proceed without performing an alarm suppression operation (e.g., allow an alarm to be reported when a missed number of echo responses reaches an alarm threshold with regard to the UPF/base station connection or tunnel to which the alert corresponds).

Method Embodiment 3. The method of Method Embodiment 1,further comprising: when it is determined that (326) the received requested information regarding ongoing data sessions indicates that there are no ongoing data sessions involving data transmission between the UPF and identified base station, generating (362) and sending (364) a message (366) to request establishment of a TCP session for a UE (dummy UE) at the identified base station (said TCP session to be used for the transmission of data between the UPF and gNB which can be used to test whether gNB to UPF connectivity is still functional).

Method Embodiment 3A. The method of Method Embodiment 3, further comprising: receiving (396) a link establishment confirmation message (for a TCP session between the base station and UPF) indicating a TCP session has been established between the UPF and identified base station (104) for the TCP session; and initiating (398) a test data flow to be sent between the UPF and identified base station as part of the established TCP session.

Method Embodiment 3AA. The method of Method Embodiment 3A, wherein said UE at the identified base station is a fictitious UE (e.g., a dummy UE identified by a UE identifier which is used for test purposes and does not correspond to an actual UE and where the identified UE is not actually present at the identified base station).

Method Embodiment 3AB. The method of Method Embodiment 3, wherein initiating (398) the test data flow between the UPF and identified base station includes sending (402) a request (404) for a flow of dummy data (using a fake UE) between UPF and base station, to a AMF (122) to be communicated to the base station (104).

Method Embodiments 4 to 6 relate to FIG. 2G which is the case where TCP session establishment and communication of dummy data between the first base station and UPF is successful, and the AMF 122 receives session establishment and data flow details in message 434 and then provides session information in steps 438, 440 which is received in step 444.

Method Embodiment 4. The method of Method Embodiment 3A, further comprising: receiving (444) session information corresponding to the established TCP session; determining (446) from the session information the status of a data link between the UPF and identified base station, said status indicating the data link is operating properly (e.g., link is ok) or there is a problem with the data link (e.g., the link is dropping packets above an acceptable threshold rate or is unable to communicate data packets).

Method Embodiment 5. The method of Method Embodiment 4, wherein determining (446) the status of the data link includes determining (448) that the data link is operating properly; and wherein the method further includes sending (454) a signal (e.g., an alarm suppression message (456) sent to the DAFIAC module 112) to suppress an alarm associated with the received alert.

Method Embodiment 6. The method of Method Embodiment 4, wherein determining (446) the status of the data link includes determining (450) that the data link is not operating properly; and wherein the method further includes deciding (470) not to suppress an alarm associated with the alert (and optionally, send (472) a signal, e.g., an alarm continue message (474) to the DAFIAC module (112) instructing the DAFIAC module (112) to continue to implement the alarm logic associated with the received alert).

Method Embodiments 7 to 8 relate to FIG. 2H which is the case where a TCP response is not received by the first base station (104) from the UPF (124) and thus data transmission between the UPF (124) and first base station (104) is not possible.]

Method Embodiment 7. The method of Method Embodiment 3A, further comprising: receiving (496) session information (494) indicating that the TCP session failed; and determining (500) from the received session information that a communications link between the UPF (124) and identified base station (104) is broken (e.g., has failed).

Method Embodiment 8. The method of Method Embodiment 7, further comprising: in response to determining (500) that the communications link between the UPF (124) and identified base station (104) is broken, allowing (502) alarm logic corresponding to the alert to proceed without taking any action to suppress the alarm.

### NUMBERED LIST OF EXEMPLARY APPARATUS EMBODIMENTS

Apparatus Embodiment 1. An alarm confirmation device (110 or 600) (e.g. a real time alarming accuracy confirmation (RTAC) device (110 or 600)) (which in some embodiments is part of an operations support system (108) which includes a device and function interface and control (DAFIAC) module (112) which may include one or more interfaces and/or functions), comprising: a receiver (RX) (616); a transmitter (TX) (618); and a processor (602) configured to: operate the alarm confirmation device to receive (300) (via receiver 616) an alert (e.g., an indication that an echo response was not received by a base station (e.g., base station 1 (104), e.g. gNB 1), which in some cases is received (294) by the OSS DAFIAC module (112) and forwarded (296) to the RTAC (110)) indicating a risk of an alarm generation with regard to base station (e.g., gNB) to User Plane Function (UPF) connectivity; identify (304) the base station (104) to which the alert corresponds; operate the alarm confirmation device to request (308) (via sending a request message from transmitter 618) data from an access and mobility management function (AMF) (122) for information regarding ongoing (e.g., live) data sessions with UEs at the identified base station (104) to which the alert corresponds (e.g., whether there are one or more live data sessions involving communication of data between the UPF (122) and identified base station (104) to which the alert corresponds); operate the alarm confirmation device to receive (318) (via receiver 616) the requested information regarding ongoing data sessions, the received requested information indicating whether at least one ongoing data session involving communication of data between the UPF and identified base station is ongoing and, when there is at least one ongoing data session, communications status information (e.g., whether the data communications is successful or problematic where problematic may and sometimes does include one or more of failed communications, dropped packets above a threshold or delays in data above an acceptable threshold) associated with the at least one ongoing data session; determine (322) if the received requested information regarding ongoing data sessions includes information for at least one ongoing data session; and operate the alarm confirmation device to take an action (334, 336 or 352, 354) with regard to the alert based on the communication status of the at least one ongoing data session, when it is determined that (324) the received requested information regarding ongoing data sessions indicates that at least one data session is ongoing,

Apparatus Embodiment 2. The alarm confirmation device (110 or 600) of Apparatus Embodiment 1, wherein said processor (602) is further configured to operate the alarm confirmation device to: suppress (334, 336) a possible alarm corresponding to the received alert (e.g., an alarm associated with the alert condition such as a communications failure alarm due to missing echo responses, the suppression operation may and sometimes does involve reset a count of missed echo responses to a lower number, e.g., zero, or increasing an alarm threshold value, or prohibiting an alert corresponding to missed echo responses for a predetermined period of time), in response to a determination that (324) the received requested information includes information for at least one ongoing data session, said at least one ongoing data session being a first ongoing data session corresponding to a first UE receiving service from the identified base station and a determination that the communications status information associated the first communications session indicates successful communications status (330).

Apparatus Embodiment 2A. The alarm confirmation device (110 or 600) of Apparatus Embodiment 1, wherein said processor (602) is configured to: operate the alarm confirmation device to allow (352) the alarm generation process with regard to the condition to which the alert corresponds to proceed without performing an alarm suppression operation (e.g., allow an alarm to be reported when a missed number of echo responses reaches an alarm threshold with regard to the UPF/base station connection or tunnel to which the alert corresponds), in response to a determination that (324) the received requested information includes information for at least one ongoing data session, said at least one ongoing data session being a first ongoing data session corresponding to a first UE receiving service from the identified base station; and a determination that the communications status information associated the first communications session indicates a problematic communications status (332).

Apparatus Embodiment 3. The alarm confirmation device (110 or 600) of Apparatus Embodiment 1, wherein said processor (602) is further configured to operate the alarm confirmation device to: generate (362) and send (364) a message (366) to request establishment of a TCP session for a UE (dummy UE) at the identified base station (said TCP session to be used for the transmission of data between the UPF and gNB which can be used to test whether gNB to UPF connectivity is still functional), when it is determined that (326) the received requested information regarding ongoing data sessions indicates that there are no ongoing data sessions involving data transmission between the UPF and identified base station.

Apparatus Embodiment 3A. The alarm confirmation device (110 or 600) of Apparatus Embodiment 3, wherein said processor (602) is further configured to: operate the alarm confirmation device to receive (396) (via receiver 616) a link establishment confirmation message (for a TCP session between the base station and UPF) indicating a TCP session has been established between the UPF and identified base station (104) for the TCP session; and operate the alarm confirmation device to initiate (398) a test data flow to be sent between the UPF and identified base station as part of the established TCP session.

Apparatus Embodiment 3AA. The alarm confirmation device (110 or 600) of Apparatus Embodiment 3A, wherein said UE at the identified base station is a fictitious UE (e.g., a dummy UE identified by a UE identifier which is used for test purposes and does not correspond to an actual UE and where the identified UE is not actually present at the identified base station).

Apparatus Embodiment 3AB. The alarm confirmation device (110 or 600) of Apparatus Embodiment 3, wherein said processor (602) is further configured to: operate the alarm confirmation device send (402) (via transmitter 618) a request (404) for a flow of dummy data (using a fake UE) between UPF and base station, to a AMF (122) to be communicated to the base station (104), as part of being configured to operate the alarm confirmation device to initiate (398) the test data flow between the UPF and identified base station.

Apparatus Embodiment 4. The alarm confirmation device (110 or 600) of Apparatus Embodiment 3A, wherein said processor (602) is further configured to: operate the alarm confirmation device to receive (444) (via receiver 616) session information corresponding to the established TCP session; and determine (446) from the session information the status of a data link between the UPF and identified base station, said status indicating the data link is operating properly (e.g., link is ok) or there is a problem with the data link (e.g., the link is dropping packets above an acceptable threshold rate or is unable to communicate data packets).

Apparatus Embodiment 5. The alarm confirmation device (110 or 600) of Apparatus Embodiment 4, wherein said processor (602) is further configured to operate the alarm confirmation device to send (454) (via transmitter 618) a signal (e.g., an alarm suppression message (456) sent to the DAFIAC module 112) to suppress an alarm associated with the received alert, in response to determining (448) that the data link is operating properly.

Apparatus Embodiment 6. The alarm confirmation device (110 or 600) of Apparatus Embodiment 4, wherein said processor (602) is configured to decide (470) not to suppress an alarm associated with the alert (and optionally, send (472) a signal, e.g., an alarm continue message (474) to the DAFIAC module (112) instructing the DAFIAC module (112) to continue to implement the alarm logic associated with the received alert), in response to determining (450) that the data link is not operating properly.

Apparatus Embodiment 7. The alarm confirmation device (110 or 600) of Apparatus Embodiment 3A, wherein said processor (602) is further configured to: operate the alarm confirmation device to receive (496) (via receiver 616) session information (494) indicating that the TCP session failed; and determine (500) from the received session information that a communications link between the UPF (124) and identified base station (104) is broken (e.g., has failed).

Apparatus Embodiment 8. The alarm confirmation device (110 or 600) of Apparatus Embodiment 7, wherein said processor (602) is further configured to: allow (502) alarm logic corresponding to the alert to proceed without taking any action to suppress the alarm, in response to determining (500) that the communications link between the UPF (124) and identified base station (104) is broken.

### NUMBERED LIST OF EXEMPLARY

### Non-Transitory Computer Readable Medium Embodiments

Non-transitory Computer Readable Medium Embodiment 1. A non-transitory computer readable medium (612) including machine executable instructions, which when executed by a processor (602) of an alarm confirmation device (110 or 600) (e.g. a real time alarming accuracy confirmation (RTAC) device (110 or 600)) (which in some embodiments is part of an operations support system (108) which includes a device and function interface and control (DAFIAC) module (112) which may include one or more interfaces and/or functions), controls the alarm confirmation device (110 or 600) to perform the steps of: receiving (300) an alert (e.g., an indication that an echo response was not received by a base station (e.g., base station 1 (104), e.g. gNB 1), which in some cases is received (294) by the OSS DAFIAC module (112) and forwarded (296) to the RTAC (110)) indicating a risk of an alarm generation with regard to base station (e.g., gNB) to User Plane Function (UPF) connectivity; identifying (304) the base station (104) to which the alert corresponds; requesting (308) data from an access and mobility management function (AMF) (122) for information regarding ongoing (e.g., live) data sessions with UEs at the identified base station (104) to which the alert corresponds (e.g., whether there are one or more live data sessions involving communication of data between the UPF (122) and identified base station (104) to which the alert corresponds); receiving (318) the requested information regarding ongoing data sessions, the received requested information indicating whether at least one ongoing data session involving communication of data between the UPF and identified base station is ongoing and, when there is at least one ongoing data session, communications status information (e.g., whether the data communications is successful or problematic where problematic may and sometimes does include one or more of failed communications, dropped packets above a threshold or delays in data above an acceptable threshold) associated with the at least one ongoing data session; determining (322) if the received requested information regarding ongoing data sessions includes information for at least one ongoing data session; and when it is determined that (324) the received requested information regarding ongoing data sessions indicates that at least one data session is ongoing, taking an action (334, 336 or 352, 354) with regard to the alert based on the communication status of the at least one ongoing data session.

The techniques of various embodiments may be implemented using software, hardware and/or a combination of software and hardware. Various embodiments are directed to apparatus, e.g., alarm confirmation devices, OSS devices, core network devices, analytics servers, other servers, base stations, e.g. gNBs, user equipments (UEs), performance management system (PMS) devices, element management system (EMS) devices, access points (AP), e.g., WiFi APs supporting 802.11be and/or future versions, stations (STAs), e.g., WiFi STAs supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating alarm confirmation devices, OSS devices, core network devices, analytics servers, other servers, base stations, e.g. gNBs, user equipments (UEs), performance management system (PMS) devices, element management system (EMS) devices, access points (AP), e.g., WiFi APs, supporting 802.11be and/or future versions, stations (STAs), e.g., WiFi STAs, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In various embodiments devices, e.g., alarm confirmation devices, OSS devices, core network devices analytics servers, other servers, base stations, e.g. gNBs, user equipments (UEs), performance management system (PMS) devices, element management system (EMS) devices, access points (AP), e.g., WiFi APs, supporting 802.11be and/or future versions, stations (STAs), e.g., WiFi STAs, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning APs, STAs, user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., alarm confirmation devices, OSS devices, core network devices analytics servers, other servers, base stations, e.g. gNBs, user equipments (UEs), performance management system (PMS) devices, element management system (EMS) devices, access points (AP), e.g., WiFi APs, supporting 802.11be and/or future versions, stations (STAs), e.g., WiFi STAs, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the alarm confirmation devices, OSS devices, core network devices, analytics servers, other servers, base stations, e.g. gNBs, user equipments (UEs), performance management system (PMS) devices, element management system (EMS) devices, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., an alarm confirmation devices, an device, a core network device, an analytics server, another server, a base station, e.g. a gNB, a user equipment (UE), performance management system (PMS) device, element management system (EMS) device, access point (AP), e.g., WiFi AP, supporting 802.11be and/or future versions, station (STA), e.g., WiFi STA, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., an alarm confirmation device, an OSS device, a core network device, an analytics server, another server, a base station, e.g. a gNB, user equipment (UE), performance management system (PMS) device, element management system (EMS) device, access points (AP), e.g., WiFi AP, supporting 802.11be and/or future versions, stations (STA), e.g., WiFi STA, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., an alarm confirmation devices, an OSS device, core network device, an analytics server, another server, a base station, e.g. a gNB, user equipment (UE), performance management system (PMS) device, element management system (EMS) devices, an access point (AP), e.g., WiFi AP, supporting 802.11be and/or future versions, a stations (STA), e.g., a WiFi STA, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as an alarm confirmation device, an OSS device, a core network devices, an analytics server, another server, a base station, e.g. a gNB, user equipments (UE), performance management system (PMS) device, element management system (EMS) device, an access points (AP), e.g., a WiFi AP, supporting 802.11be and/or future versions, a station (STA), e.g., WiFi STA, supporting 802.11be and/or future versions, a user equipment device, wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating an alarm confirmation device, the method comprising:
receiving an alert indicating a risk of an alarm generation with regard to base station to User Plane Function (UPF) connectivity;
identifying the base station to which the alert corresponds;
receiving information regarding ongoing data sessions with user equipments (UEs) at the identified base station to which the alert corresponds from an access and mobility management function (AMF), the received information indicating whether at least one ongoing data session involving communication of data between the UPF and identified base station is ongoing and, when there is at least one ongoing data session, communications status information associated with the at least one ongoing data session; and
when the received information regarding ongoing data sessions indicates that at least one data session is ongoing, taking an action with regard to the alert based on the communication status of the at least one ongoing data session.

2. The method of claim 1,
wherein the received information regarding ongoing data sessions includes information for at least one ongoing data session, said at least one ongoing data session being a first ongoing data session corresponding to a first UE receiving service from the identified base station;
wherein communications status information, included in the received information, associated the first communications session indicates successful communications status; and
wherein the method further includes suppressing a possible alarm corresponding to the received alert.

3. The method of claim 1, further comprising:
when the received information regarding ongoing data sessions indicates that there are no ongoing data sessions involving data transmission between the UPF and identified base station, generating and sending a message to request establishment of a TCP session for a UE at the identified base station.

4. The method of claim 3, further comprising:
receiving a link establishment confirmation message indicating a TCP session has been established between the UPF and identified base station for the TCP session; and
initiating a test data flow to be sent between the UPF and identified base station as part of the established TCP session.

5. The method of claim 4, wherein said UE at the identified base station is a fictitious UE.

6. The method of claim 4, further comprising:
receiving session information corresponding to the established TCP session;
determining from the session information the status of a data link between the UPF and identified base station, said status indicating the data link is operating properly or there is a problem with the data link.

7. The method of claim 6, wherein determining the status of the data link includes determining that the data link is operating properly; and
wherein the method further includes sending a signal to suppress an alarm associated with the received alert.

8. The method of claim 6, wherein determining the status of the data link includes determining that the data link is not operating properly; and
wherein the method further includes deciding not to suppress an alarm associated with the alert.

9. The method of claim 4, further comprising:
receiving session information indicating that the TCP session failed; and
determining from the received session information that a communications link between the UPF and identified base station is broken.

10. The method of claim 9, further comprising:
in response to determining that the communications link between the UPF and identified base station is broken, allowing alarm logic corresponding to the alert to proceed without taking any action to suppress the alarm.

11. An alarm confirmation device comprising:
a receiver;
a transmitter; and
a processor configured to:
operate the alarm confirmation device to receive an alert indicating a risk of an alarm generation with regard to base station to User Plane Function (UPF) connectivity;
identify the base station to which the alert corresponds;
receive information regarding ongoing data sessions with user equipments (UEs) at the identified base station to which the alert corresponds from an access and mobility management function (AMF), the received information indicating whether at least one ongoing data session involving communication of data between the UPF and identified base station is ongoing and, when there is at least one ongoing data session, communications status information associated with the at least one ongoing data session; and
when the received information regarding ongoing data sessions indicates that at least one data session is ongoing, taking an action with regard to the alert based on the communication status of the at least one ongoing data session.

12. The alarm confirmation device of claim 11, wherein said processor is further configured to operate the alarm confirmation device to:
suppress a possible alarm corresponding to the received alert, when the received information regarding ongoing data sessions includes information corresponding to a first ongoing data session corresponding to a first UE receiving service from the identified base station with the received information indicating a successful communications status for the first ongoing data session.

13. The alarm confirmation device of claim 11, wherein said processor is further configured to operate the alarm confirmation device to:
generate and send a message to request establishment of a TCP session for a UE at the identified base station, when the received information regarding ongoing data sessions indicates that there are no ongoing data sessions involving data transmission between the UPF and identified base station.

14. The alarm confirmation device of claim 13, wherein said processor is further configured to:
operate the alarm confirmation device to receive a link establishment confirmation message indicating a TCP session has been established between the UPF and identified base station for the TCP session; and
operate the alarm confirmation device to initiate a test data flow to be sent between the UPF and identified base station as part of the established TCP session.

15. The alarm confirmation device of claim 14, wherein said UE at the identified base station is a fictitious UE.

16. The alarm confirmation device of claim 14, wherein said processor is further configured to:
operate the alarm confirmation device to receive session information corresponding to the established TCP session; and
determine from the session information the status of a data link between the UPF and identified base station, said status indicating the data link is operating properly or there is a problem with the data link.

17. The alarm confirmation device of claim 16, wherein said processor is further configured to operate the alarm confirmation device to send a signal to suppress an alarm associated with the received alert, in response to determining that the data link is operating properly.

18. The alarm confirmation device of claim 16, wherein said processor is configured to decide not to suppress an alarm associated with the alert, in response to determining that the data link is not operating properly.

19. The alarm confirmation device of claim 15, wherein said processor is further configured to:
operate the alarm confirmation device to receive session information indicating that the TCP session failed; and
determine from the received session information that a communications link between the UPF and identified base station is broken.

20. A non-transitory computer readable medium including machine executable instructions, which when executed by a processor of an alarm confirmation device, controls the alarm confirmation device to perform the steps of:
receiving an alert indicating a risk of an alarm generation with regard to base station to User Plane Function (UPF) connectivity;
identifying a base station to which the alert corresponds;
receiving information regarding ongoing data sessions with user equipments (UEs) at the identified base station to which the alert corresponds from an access and mobility management function (AMF), the received information indicating whether at least one ongoing data session involving communication of data between the UPF and identified base station is ongoing and, when there is at least one ongoing data session, communications status information associated with the at least one ongoing data session; and
taking an action with regard to the alert based on the communication status of the at least one ongoing data session when the received information regarding ongoing data sessions indicates that at least one data session is ongoing.
